(19) United States
(12) Patent Application Publication
(10) Pub. No.: US 2004/0251250 A1
(43) Pub. Date: Dec. 16, 2004

(54) Microwave oven mixing device and method of using the same

(76) Inventor: Michael Steven Haedrich, Portland, OR (US)

Correspondence Address: Ingrid McTaggart, 534 SE. 58th Avenue, Portland, OR, 97215, US

(21) Appl. No.: 10/653,405

(22) Filed: Sep. 2, 2003

Related U.S. Application Data
(60) Provisional application No. 60/477,167, filed on Jun. 10, 2003.

(51) Int. Cl. H05B 6/80

(52) U.S. Cl. 219/726

(57) ABSTRACT

One embodiment of a microwave oven mixing device includes a mounting bracket structured for securement to an interior surface of a cooking compartment of a microwave oven, a horizontal beam pivotally mounted to the mounting bracket and structured for pivotal movement on the mounting bracket during operation of the microwave oven, and a mixing blade operatively connected to the horizontal beam and structured for placement within a food container during operation of the microwave oven.

This application claims priority of provisional patent application Ser. No. 60/477,167, filed on Jun. 10, 2003.

### BACKGROUND

Microwave ovens are commonly used to reheat and/or cook foods and liquids such as soups and the like. A“microwave” generally is defined as a short electromagnetic wave, often between about one millimeter and one meter in wavelength. Microwave ovens cook foods by utilizing the heat produced as a result of microwave penetration of the food. This penetration of the food by microwaves is often uneven so that food cooked in a microwave oven may have hot or cold spots. To alleviate this uneven heating of foods cooked within a microwave, many microwave ovens include rotary platforms that rotate a container supporting the food as the food is cooked within the microwave oven. Such rotary platforms do eliminate some hot and cold spots but do not entirely alleviate the problem. However, a microwave oven will only operate when the oven door is closed. Accordingly, stirring the food during operation of a microwave oven is not possible.

To further remove such hot and cold spots, and to more evenly cook food in a microwave oven, many microwave oven users will open the microwave oven door periodically during cooking and stir the food. This requires the user to stay near the microwave during cooking and to repeatedly stop the cooking process to open the microwave door. In between stirring, the stirring utensil must be held by the microwave oven user or placed on a surface where the stirring utensil may become contaminated or may dirty the surface.

One prior art device, U.S. Pat. No. 4,904,834 to Bowers, attempts to alleviate the problems of hot and cold spots in microwave cooked foods by providing a Mixing Attachment for Microwave Oven Turntables. Bowers provides a horizontal arm that is rigidly secured to an inner surface of the microwave oven and a vertical arm having a stirring blade. The vertical arm is rigidly secured to the horizontal arm during cooking. Adjustment of the Bowers mixing attachment is time consuming and inconvenient and may only be accomplished manually when the device may be accessed by the user, such as when the microwave oven is not in use.

### BRIEF DESCRIPTION OF THE DRAWINGS

FIG. 1A is a side view of one embodiment of a microwave oven mixing device showing the mixing blade in a raised position and the horizontal arm positioned adjacent a mounting bracket.

FIG. 1B is a perspective view of the mixing device of FIG. 1A.

FIG. 2A is a perspective view of one embodiment of the mixing device with the blade in a raised position.

FIG. 2B is a perspective view of one embodiment of the mixing device with the blade in a lowered position.

FIG. 2C is a perspective view of one embodiment of the mixing device with the blade removed from the vertical arm.

FIG. 2D is a front cross-sectional view showing one embodiment of the ratchet mechanism of the mixing blade.

FIG. 3A is a perspective view of one embodiment of the mixing device with the vertical arm in a downward position.

FIG. 3B is a perspective view of one embodiment of the mixing device with the vertical arm in a rotated position.

FIG. 3C is a perspective view of one embodiment of the mixing device with the vertical arm in a horizontal position.

FIG. 3D is a perspective view of one embodiment of the mixing device with the vertical arm removed from the horizontal arm and showing the connect mechanism of the vertical arm to the horizontal arm.

FIG. 4A is a perspective view showing one embodiment of the horizontal arm positioned adjacent to the mounting bracket.

FIG. 4B is a perspective view showing one embodiment of the horizontal arm telescoped outwardly from the mounting bracket.

FIG. 5A is a perspective view showing one embodiment of the horizontal arm pivoted rearwardly with respect to the mounting bracket.

FIG. 5B is a perspective view showing one embodiment of the horizontal arm pivoted forwardly with respect to the mounting bracket.

FIG. 5C is a perspective view showing one embodiment of the horizontal arm fully pivoted forwardly with respect to and positioned adjacent to the mounting bracket.

FIG. 6A is a perspective view showing removal of one embodiment of the horizontal arm from the mounting bracket.

FIG. 6B is a perspective detailed view showing removal of one embodiment of the horizontal arm from the mounting bracket of FIG. 6A.

FIG. 6C is a perspective view showing full removal of one embodiment of the horizontal arm from the mounting bracket.

FIG. 7A is a perspective view of one embodiment of a mixing blade.

FIG. 7B is a perspective view of another embodiment of a mixing blade.

FIG. 7C is a perspective view of another embodiment of a mixing blade.

FIG. 7D is a perspective view of another embodiment of a mixing blade.

FIG. 8 is a side view of a mixing device positioned within a microwave oven.

FIG. 9 is perspective view showing another embodiment of the microwave oven mixing device.

FIG. 10 is a perspective view of the mixing device of FIG. 9 showing the vertical arm disconnected from the horizontal arm.

FIG. 11 is perspective view of the mounting bracket of the mixing device of FIG. 9.

FIG. 12 is a perspective view of the mixing device of FIG. 9 showing the horizontal arm extended on the horizontal beam.

FIG. 13 is a perspective view of the mixing device of FIG. 12 showing the horizontal arm removed from the horizontal beam.

FIG. 14 is perspective view of another embodiment of the microwave oven mixing device showing the mounting bracket and a mounting plate.

FIG. 15 is a perspective view of the mixing device of FIG. 14 showing the mounting bracket secured on the mounting plate.

### DETAILED DESCRIPTION OF THE DRAWINGS

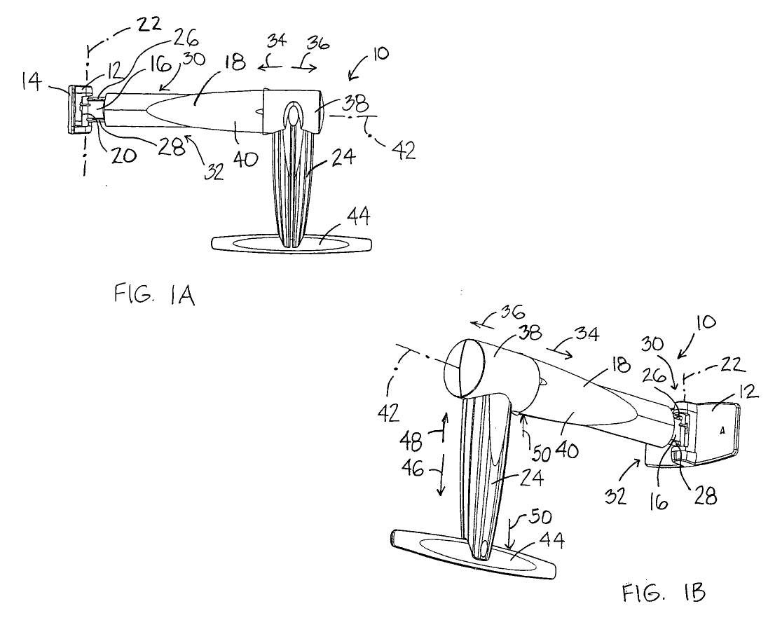

FIG. 1A is a side view of one embodiment of a microwave oven mixing device 10 according to the present invention showing the mixing blade in a raised position and the horizontal arm positioned adjacent to a mounting bracket. In particular, mixing device 10 may comprise a mounting bracket 12 secured to an inside surface of a microwave oven (not shown). Bracket 12 may be secured to any inside surface of the microwave oven such as an inner side wall, rear wall, door, ceiling or floor surface. Mounting bracket 12 may be secured to the inside surface of the microwave oven by any appropriate means. In the embodiment shown, bracket 12 may be secured to an inside surface by use of double-stick foam tape 14. Fasteners such as screws or bolts (not shown) or any other type of fastener may also be used. In yet another embodiment, the microwave may have a bracket receiving mount manufactured integral with an inner surface of the microwave oven.

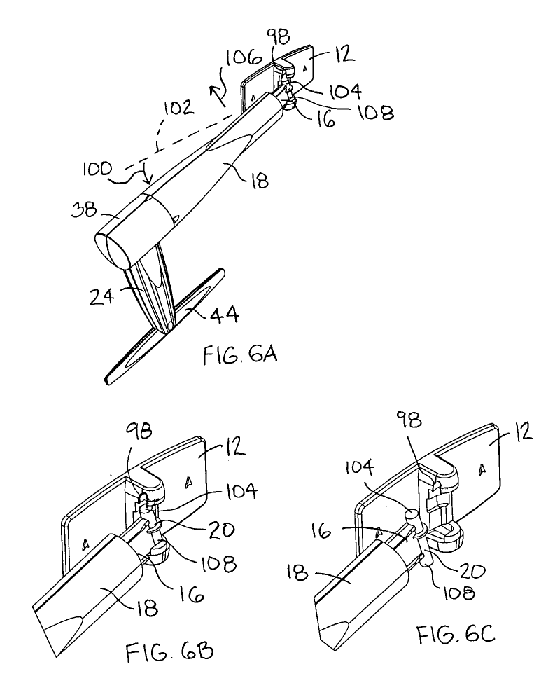

Mixing device 10 further comprises a horizontal beam 16 and a horizontal arm 18 removably secured thereto. Horizontal beam 16 may include a vertically positioned pivot bar 20 that is removably secured within mounting bracket 12, as will be more fully described with reference to FIG. 6. Pivot bar 20 allows horizontal beam 16 to swing in an arc about a pivot axis 22 of pivot bar 20 such that horizontal bar 16 may pivot with respect to mounting bracket 12. This pivotal movement allows horizontal arm 18, and a vertical arm 24 secured thereto, to be moved out of a central portion of the microwave oven when the mixing device is not in use.

Horizontal beam 16 may have raised projections 26 and 28 extending along an upper region 30 and a lower region 32 of beam 16, respectively, such that beam 16 has the general cross-sectional shape of an“I-beam.” Such an I-beam construction adds strength to beam 16. Furthermore, raised projections 26 and 28 may be received within mating recesses (not shown) of an interior of horizontal arm 18 such that arm 18 is guided for telescoping movement in directions 34 and 36 along beam 16. In this manner, vertical arm 24, which is attached to horizontal arm 18, may be moved along directions 34 and 36 toward and away from, respectively, mounting bracket 12. Accordingly, mixing device 12 may be adjusted for use in a microwave oven of virtually any size. Moreover, a force applied by food on vertical arm 24 during cooking may cause telescoping movement of arm 18 on beam 16 during cooking so that vertical arm 24 remains positioned within a container of food (not shown) during cooking, even when the container of food is not centered on a rotating turntable (not shown) positioned within a microwave oven. The mixing device 10 of the present invention, therefore,“tracks” the movement of a container within a microwave oven without requiring manual intervention by a microwave operator during use. This speeds up the cooking process and allows the microwave oven operator to leave the microwave oven unattended during operation.

Mixing device 10 may further comprise vertical arm 24 secured to an end region 38 of horizontal arm 18. End region 38 of horizontal arm 18 may be rotatably mounted on a central region 40 of horizontal arm 18 such that end region 38 may rotate about an axis 42 of horizontal arm 18. Rotation of end region 38, and vertical arm 24, about axis 42 may allow a mixing blade 44 secured to vertical arm 24 to be moved upwardly and out of the way of a food container when the container is placed in or removed from a microwave oven. Rotation of vertical arm 24 about axis 42 may be conducted by the microwave oven operator with one hand so that the operator may hold the food container with their other hand.

FIG. 1B is a perspective view of the mixing device 10 of FIG. 1A. In this figure, similar to FIG. 1, horizontal arm 18 is shown moved in direction 34 such that arm 18 is positioned adjacent bracket 12. Vertical arm 24 is shown extending straight downwardly in direction 46 such that blade 44 is positioned for mixing food within a food container (not shown). Blade 44 is also shown moved in an upward direction 48 within vertical arm 24 such that a distance 50 from end region 38 of horizontal arm 18 to mixing blade 44 is at a minimum. Of course, any length of vertical arm 24 and mixing blade 44 may be used such that mixing device 10 can be used with any sized microwave oven.

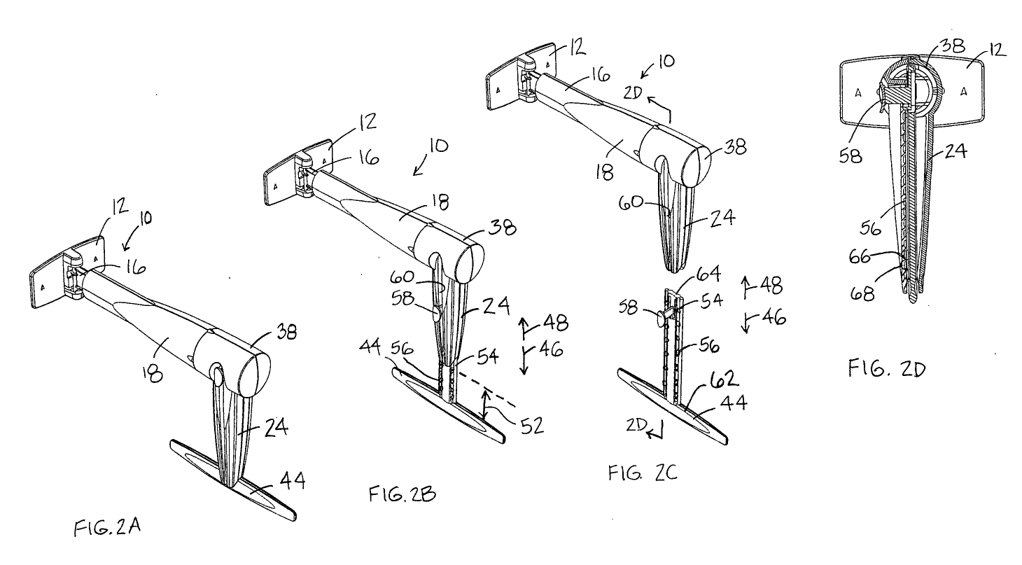

FIG. 2A is a perspective view of one embodiment of the mixing device 10 with the blade 44 in a raised position, i.e., with blade 44 moved upwardly within vertical arm 24.

FIG. 2B is a perspective view of one embodiment of the mixing device 10 with blade 44 in a somewhat lowered position. In particular, blade 44 is shown lowered a distance 52 from its raised position shown in FIG. 2A. In the embodiment shown, blade 44 includes a vertical bar 54 received within an interior of vertical arm 24. Vertical bar 54 of the mixing blade may include outwardly extending projections 56 that are received within one or more mating recesses (see FIG. 2D) on an interior surface of vertical arm 24. In this manner, vertical bar 54 may be “indexed” upwardly in direction 48 or downwardly in direction 46 in incremental movements, wherein each of projections 56, when received in the mating recesses of vertical arm 24, will provide a predetermined amount of force to retain vertical bar 54 stationary in that position.

Movement of vertical bar 54 in either of directions 46 or 48 is most easily accomplished by movement of a ratchet knob 58, secured to vertical bar 54, wherein knob 58 moves within a groove 60 of vertical arm 24. Due to the presence of ratchet knob 58, the microwave oven operator may adjust the height of mixing blade 44 without touching the lower food contacting portion 62 of blade 44 and without touching the food being cooked.

FIG. 2C is a perspective view of one embodiment of the mixing device 10 with blade 44 removed from vertical arm 24. Groove 60 of vertical arm 24 may extend to the lower end of arm 24 such that ratchet knob 58, along with the remainder of mixing blade 44, may be removed from vertical arm 24. In this manner, mixing blade 44 may be removed for cleaning without dismantling mixing device 10. Accordingly, blade 44 can be removed for cleaning while leaving bracket 12, horizontal bar 16, horizontal arm 18 and vertical arm 24 remaining secured within the microwave oven.

Still referring to FIG. 2C, vertical bar 54 of mixing blade 44 typically has a generally flat cross sectional shape, as shown by top surface 64 of bar 54, which is received within a mating generally flat shaped groove in an interior of vertical arm 24. Accordingly, mixing blade generally will not rotate about vertical bar 54 such that contact of food contacting portion 62 of blade 44 with food in a container will force the food to move around portion 62, thus mixing the food, rather than the food contacting portion 62 of blade 44 and rotating blade 44 as the food passes thereby. In other words, as food within a container rotates within a microwave oven upon rotation of the rotation platform on which the container sits (not shown), portion 62 of blade 44 will remain stationary, thereby mixing the food as the food cooks and turns on the rotation platform.

FIG. 2D is a front cross-sectional view, taken along line 2D-2D of FIG. 2C, showing one embodiment of the ratchet mechanism of the mixing blade. In particular, ratchet mechanism 64 of mixing device 10 may include projections 56 on vertical bar 54 of mixing blade 44, and mating recesses 66 on interior surface 68 of vertical arm 24. Of course, other ratchet mechanisms may be used to movably secure mixing blade 44 within vertical arm 24.

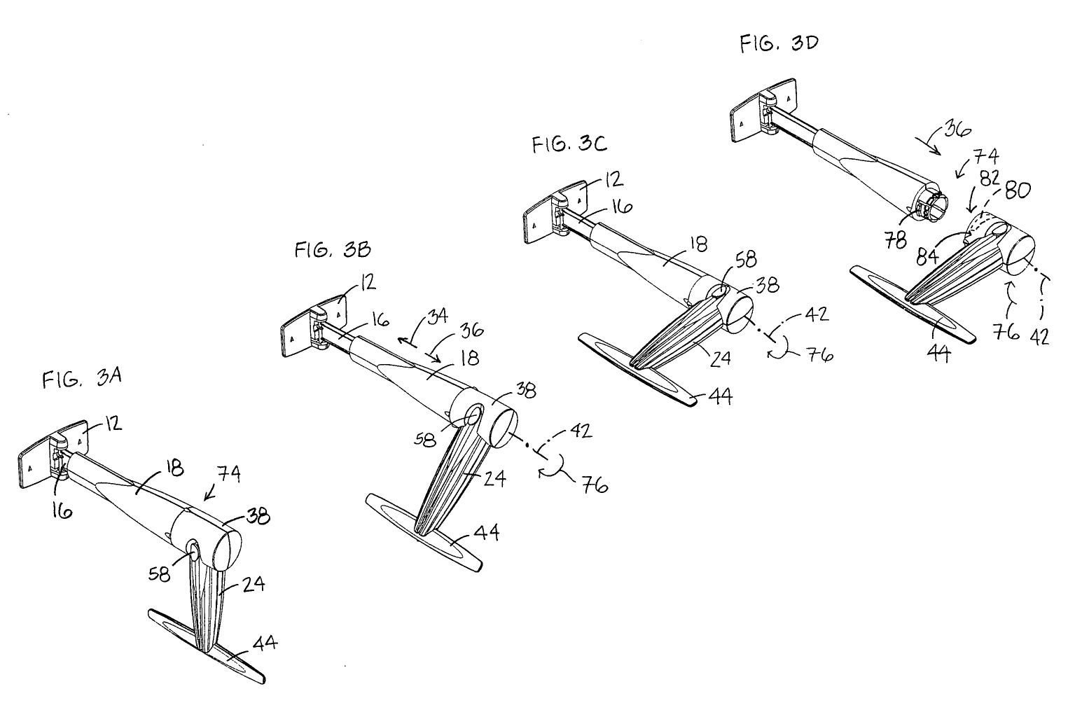

FIG. 3A is a perspective view of one embodiment of mixing device 10 with vertical arm 24 in a downward position. In this downward or mixing position, end region 38 of horizontal arm 18 may be locked in position, relative to horizontal bar 16, by a locking mechanism 74 (see FIG. 3D). Locking of arm 24 in this mixing position allows mixing blade 44 to resist the force created by food in a container that rotates on a microwave oven rotary platform (not shown). In other words, mixing blade 44 will remain stationary as food passes over the blade, thereby automatically mixing or stirring the food as it cooks.

FIG. 3B is a perspective view of one embodiment of mixing device 10 with horizontal arm 18 moved slightly outwardly in direction 36 from bracket 12 and with vertical arm 24 rotated slightly upwardly in a direction 76 about axis 42. Upwardly rotation of vertical arm 24 about axis 42 allows mixing blade 44 to be removed from a food container such that the microwave oven operator may visually inspect the food or remove the food container from the microwave oven.

FIG. 3C is a perspective view of one embodiment of mixing device 10 with vertical arm 24 rotated about axis 42 to a somewhat horizontal position such that mixing blade 44 is fully out of the way of a food container being placed in or being removed from a microwave oven. In particular, end region 38 may include a ratchet mechanism that mates with central region 40 of horizontal arm 18 such that vertical arm 24 may be retained in an upright position approximately eight five degrees in direction 76 from the downward position shown in FIG. 3A. In this somewhat horizontal orientation of vertical arm 24, end region 38 of horizontal arm 18 may be retained on central region 40 of horizontal arm 18 without end region 38 becoming loose with respect to central region 40.

FIG. 3D is a perspective view of one embodiment of mixing device 10 with vertical arm 24 moved to a position rotated approximately ninety degrees in direction 76 from the downward position shown in FIG. 3A. In this fully horizontal position, vertical arm 24 may be removed from horizontal arm 18. In particular, at ninety degrees of rotation in direction 76, locking mechanism 74 has been released such that end region 38 of horizontal arm 18 is removed from central region 40 of horizontal arm. In the embodiment shown, locking mechanism 74 comprises at least one raised projection 78 on central region 40 of horizontal arm 18 and a guide wall 80 (shown in dash lines) on an interior surface 82 of end region 38. Guide wall 80 includes at least one opening 84 which allows raised projection 78 to slide therethrough when projection 78 is aligned with opening 84. In the embodiment shown, projection 78 is aligned with opening 84 when vertical arm 24 is rotated ninety degrees in direction 76 about axis 42 from the downward mixing position shown in FIG. 3A. Accordingly, in the position shown in FIG. 3D, end region 38 may be moved outwardly in direction 36 from central region 40 of horizontal arm 18 to completely remove vertical arm 24 from central region 40 of horizontal arm 18. Removal of end region 38 may allow an operator to change the mixing blade retained within vertical arm 24, clean vertical arm 24 if food is adhered thereto, or store the vertical arm and the mixing blade when not in use.

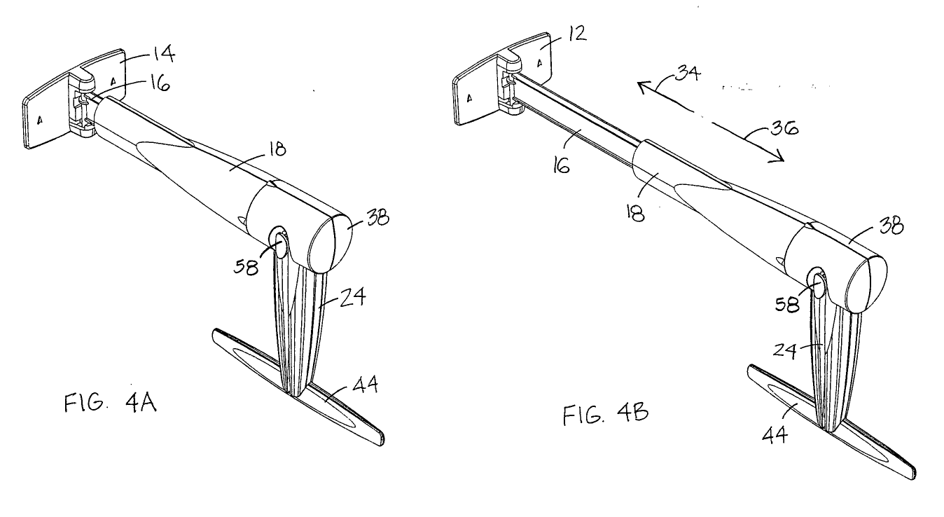

FIG. 4A is a perspective view showing one embodiment of horizontal arm 18 positioned adjacent mounting bracket 12. In this position, mixing device 10 may be positioned for use in a relatively small microwave oven.

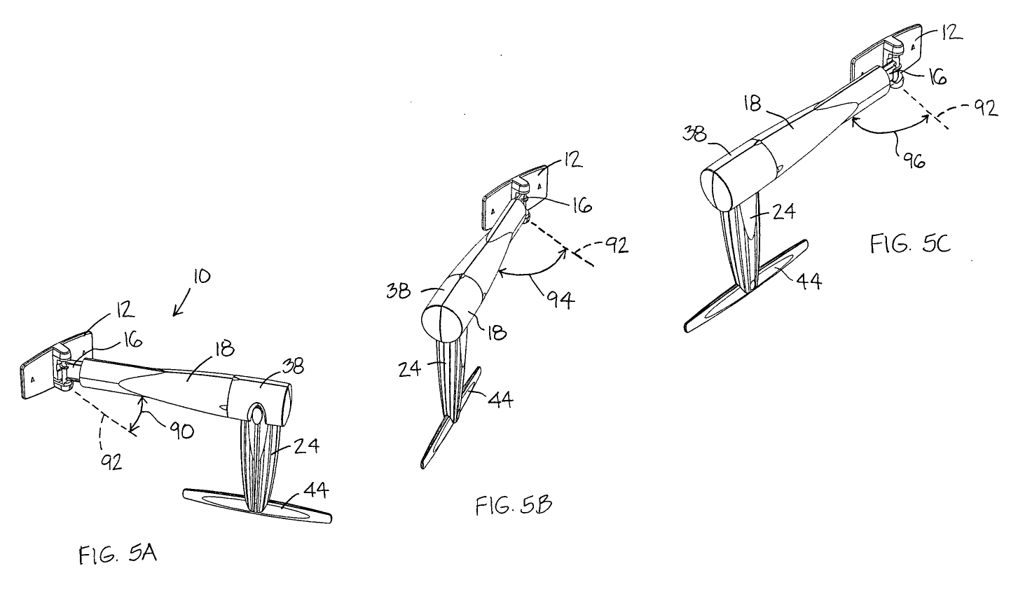

FIG. 4B is a perspective view showing one embodiment of horizontal arm 18 telescoped outwardly on horizontal beam 16 in direction 36 from mounting bracket 12. In this outward position mixing device 10 may be positioned for use in a relatively large microwave oven. Moreover, as stated earlier, arm 18 may be moved inwardly in direction 34 toward bracket 12 and outwardly in direction 36 from bracket 12 by the force of a bowl on a rotary platform (not shown) within a microwave oven. In other words, a bowl that is not centered on a rotating platform of the microwave oven would move toward and away from bracket 12 as the bowl is rotated during cooking. Due to the telescoping relationship between horizontal beam 16 and horizontal arm 18, and due the pivoting relationship between bracket 12 and horizontal beam 16 (see FIGS. 5A-5C), mixing device 10 may automatically “track” or follow the food container as it moves on the rotating platform. This self adjusting feature of the present invention occurs during operation of the microwave oven while the door is closed and without requiring manual adjustment by the microwave oven operator during operation of the microwave oven.

FIG. 5A is a perspective view showing one embodiment of horizontal beam 16 pivoted in a rearward direction from the position shown in FIGS. 4A and 4B. In particular, beam 16 and arm 18 are pivoted rearwardly through a horizontal angle 90 of approximately forty five degrees from a position 92 (shown in dash lines) extending straight outwardly from bracket 12. Such pivotal movement of beam 16 an arm 18 allows mixing blade 44 to automatically track the food container during heating when the container is not centered on a rotating platform within the microwave oven and also allows the horizontal arm 18 and blade 44 to be moved out of the central portion of a microwave oven during placement of a container in or removal of a container from the microwave oven. Such pivotal movement also allows arm 18 and blade 44 to be positioned adjacent a side wall of the microwave oven when mixing device 10 is not in use.

FIG. 5B is a perspective view showing one embodiment of horizontal beam 16 and horizontal arm 18 pivoted forwardly through a horizontal angle 94 of approximately seventy degrees from a position 92 (shown in dash lines) extending straight outwardly from bracket 12.

FIG. 5C is a perspective view showing one embodiment of horizontal beam 16 and horizontal arm 18 pivoted forwardly through a horizontal angle 96 of approximately ninety degrees from a position 92 (shown in dash lines) extending straight outwardly from bracket 12. In this position a food container may easily be placed within or removed from the microwave oven.

FIG. 6A is a perspective view showing removal of one embodiment of horizontal beam 16 and arm 18 from mounting bracket 12. In the ninety degree rotated position shown in FIG. 5C, pivot bar 20 of horizontal beam 16 is aligned with a recess 98 of mounting bracket 12. Alignment of pivot bar 20 with recess 98 allows horizontal beam 16 to be pivoted downwardly in a direction 100 from a horizontal position 102 (shown in dash lines) so that a top portion 104 of pivot bar 20 moves through recess 98 and is removed from bracket 12. Once top portion 104 of pivot bar 20 is removed from bracket 12, beam 16 may be lifted generally upwardly in a direction 106 so as to remove a lower portion 108 of pivot bar 20 from bracket 12. In this manner, horizontal beam 16, horizontal arm 18, vertical arm 24 and mixing blade 44 may be removed as an integral unit from mounting bracket 12. Removal of these components so that only bracket 12 remains in the microwave oven may be desirable for cleaning and/or storage of the mixing device. In positions other than the ninety degree rotated position of horizontal beam 16 shown in FIG. 5C, bracket 12 retains pivot bar 20 therein such that horizontal beam 16 may not be removed from bracket 12.

FIG. 6B is a perspective view showing a detailed view of the removal of beam 16 from mounting bracket 12 as shown in FIG. 6A. In particular, pivot bar 20 is shown being moved through recess 98 of bracket 12.

FIG. 6C is a perspective view showing full removal of horizontal beam 16 from mounting bracket 12. In particular, pivot bar 20 is shown completely removed from mounting bracket 12.

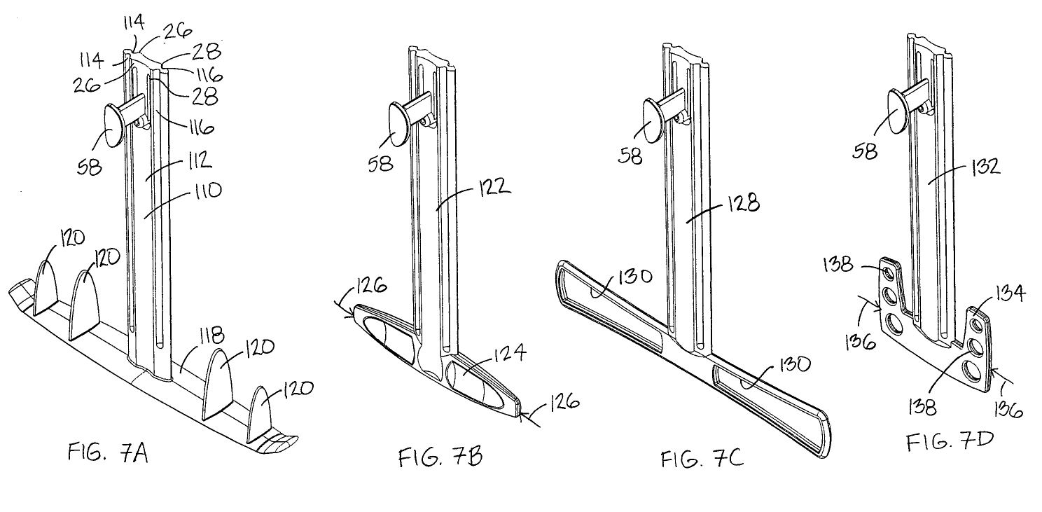

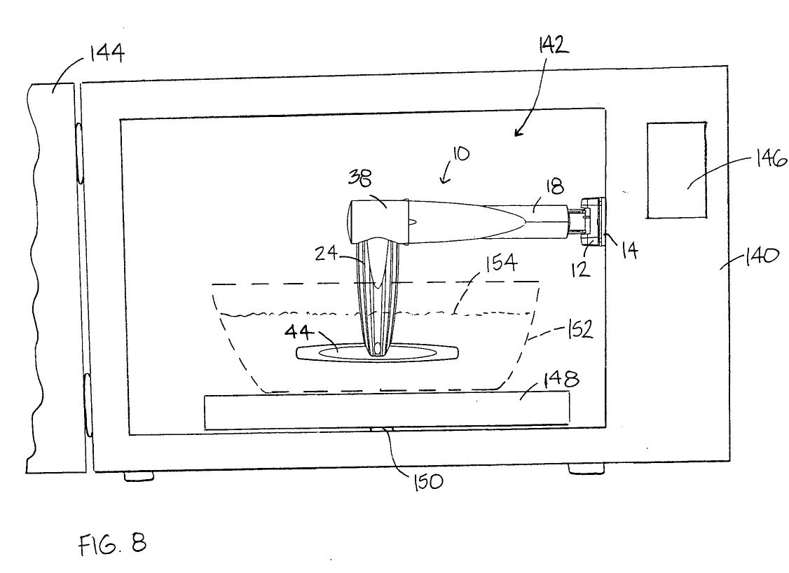

FIG. 7A is a perspective view of one embodiment of a mixing blade 110. Mixing blade 110 may be used for mixing pasta or the like. In this embodiment, raised projections 26 and 28 each define a ridge positioned along a length of a vertical arm 112 of blade 110, and adjacent recesses 114 and 116, respectively, also extending along a length of vertical arm 112. Projections 26 and 28 and recesses 114 and 116 are each received within mating structure of vertical arm 24 such that blade 110 is frictionally secured therein. A lower region 118 of blade 110 may include upwardly extending teeth 120 that function to mix pasta held within a food container.

FIG. 7B is a perspective view of another embodiment of a mixing blade 122. Blade 122 includes a lower region 124 that has a width 126 generally shorter than the width of blade 44 shown in FIG. 1A. Short mixing blade 124 may be used for small food containers such as cereal bowl sized containers and single serving storage containers.

FIG. 7C is a perspective view of another embodiment of a mixing blade 128. Blade 128 may be used for whipping items. Accordingly, blade 128 includes cut out regions 130 within the blade.

FIG. 7D is a perspective view of another embodiment of a mixing blade 132. Blade 132 has a lower region 134 having a width 136 generally shorter than the width of short mixing blade 124. Lower region 134 may also include several holes 138 to facilitate stirring by the blade. Blade 132 may be used for stirring liquids in small containers such as coffee or tea contained in mugs or cups.

FIG. 8 is a side view of mixing device 10 positioned within a microwave oven 140. Oven 140 may include an interior cooking compartment 142 which is enclosed by a door 144 (shown partially) during operation. Operation of the microwave oven may be controlled by a control panel 146 which receives input from an operator and displays signals to the operator such as the power setting and cooking time of the microwave oven. Interior cooking compartment 142 may include a platform 148 that rotates about a rotational axis 150 during operation of the microwave oven. A food container such as a bowl 152 (shown in dash lines) with food or liquid 154 contained therein (shown in dash lines) may be placed on platform 148 during cooking of food or liquid 154. After placement of container 152 on platform 142, mixing device 10 may be manipulated such that mixing blade 44 is positioned downwardly within food 154. Thereafter, the operator may shut door 144, and enter the appropriate cooking setting on control panel 146 to commence the cooking operation. During cooking, platform 148 will rotate thereby rotating container 152. Rotation of container 152 will rotate food 154 which will then pass over blade 44. Mixing device 10 is self adjusting such that if container 152 is not centered on platform 148, the blade will follow the circular movement of container 152 as it moves within oven 140. Accordingly, the food is stirred and/or mixed during cooking without requiring the microwave operator to open door 144 during cooking.

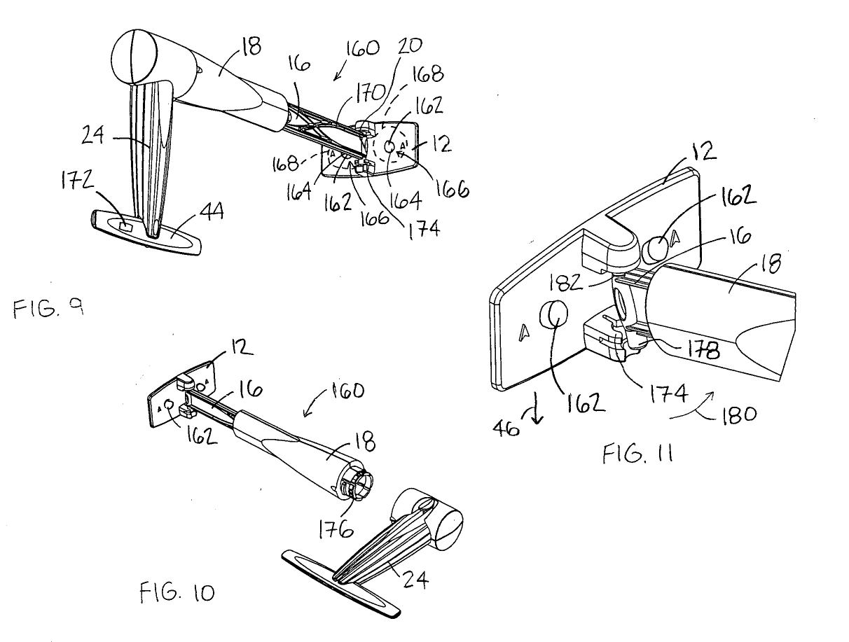

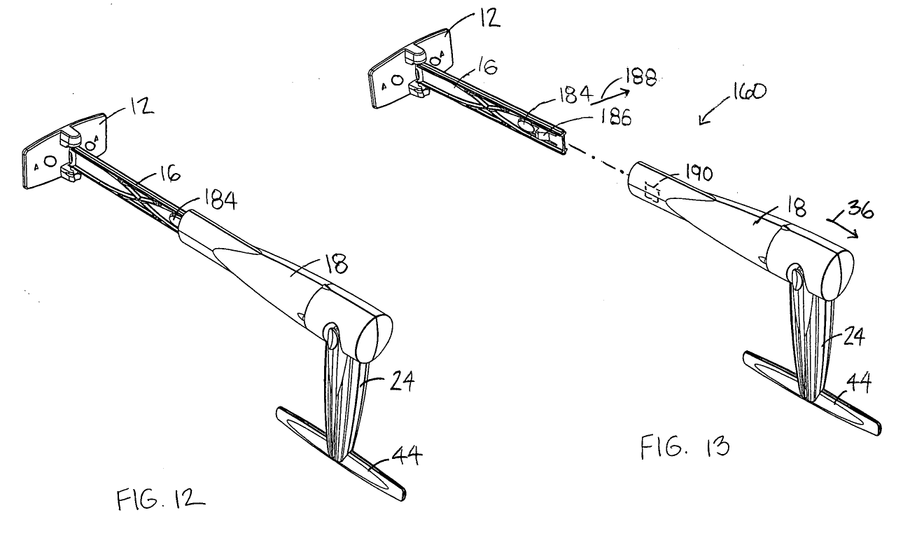

FIG. 9 is perspective view showing another embodiment of the microwave oven mixing device 160. Mixing device 160 may include two suction cups 162 secured to mounting bracket 12. Each of suction cups 162 may include a forward portion 164 extending through an aperture 166 in mounting bracket 12 and a rearward suction portion 168 (shown in dash lines behind bracket 12) for securing suction cup 162 to an interior surface of the microwave oven.

In this embodiment mixing device 160 may include several features not shown on the mixing device shown in FIG. 1. In particular, mixing device 160 may include an“X” pattern of raised projections 170 on horizontal beam 16 which may add strength and stability to horizontal beam 16. Blade 44 may include a temperature sensing device 172 that may sense and indicate a temperature of the blade. In this manner, an operator may view temperature sensing device 172 to determine a temperature of food being mixed or stirred by blade 44. Mounting bracket 12 may include two snap arms 174 that enclose a lower portion of pivot bar 20 and retain horizontal beam 16 on bracket 12 until an operator removes pivot bar 20 from its frictional engagement within snap arms 174.

FIG. 10 is a perspective view of mixing device 160 of FIG. 9 showing vertical arm 24 disconnected from horizontal arm 18 by rotation of vertical arm 24 about projections 176 of arm 18. The arrangement of projections 176 shown in FIG. 10 is a slight modification of the projections 78 shown in FIG. 3D but accomplishes the same purpose, namely, retention of vertical arm 24 on horizontal arm 18 until vertical arm 24 is rotated to a predetermined release position, shown in FIG. 10.

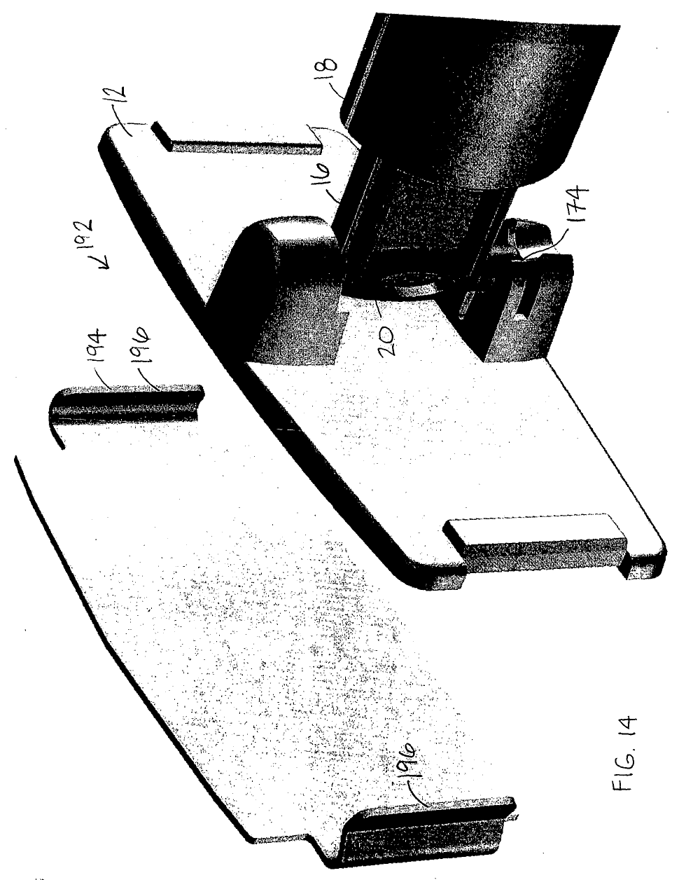

FIG. 11 is perspective view of mounting bracket 12 of mixing device 160 of FIG. 9 showing pivot bar 20 being removed from snap arms 174 by movement of a lower region 178 of bar 20 in a direction 180. Once lower region 178 of pivot bar 20 is removed from snap arms 174, an upper region 182 of pivot bar 20 may be moved downwardly in direction 46 to remove horizontal beam 16 from mounting bracket 12.

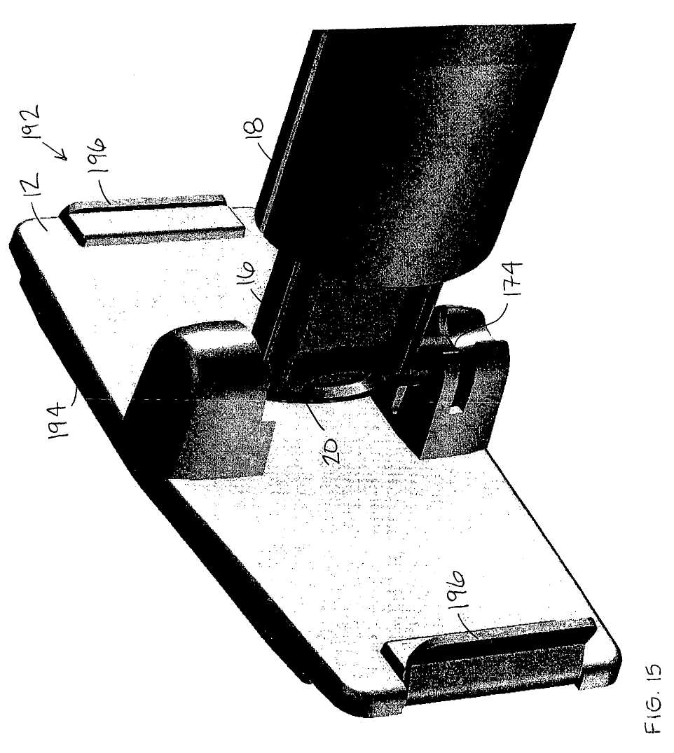

FIG. 12 is a perspective view of mixing device 160 of FIG. 9 showing horizontal arm 18 extended on horizontal beam 16. Horizontal beam 16 may include a release button 184 that when depressed will allow removal of arm 18 from beam 16, as shown in FIG. 13.

FIG. 13 is a perspective view of mixing device 160 of FIG. 12 showing horizontal arm 18 removed from horizontal beam 16. Horizontal beam 16 may include release button 184 that is connected to a raised projection 186, also referred to herein as a release projection. Depression of release button 184 in a direction 188 may cause corresponding movement of raised projection 186 in direction 188 such that raised projection 186 is removed from a mating recessed region 190 (shown in dash lines) on an interior of horizontal arm 18, whereby arm 18 may be removed from beam 16 in direction 36.

FIG. 14 is perspective view of another embodiment of a microwave oven mixing device 190 showing mounting bracket 12 and a mounting plate 192. Mounting plate 192 may include outwardly extending arms 194 that may frictionally retain bracket 12 therein. Bracket 12 may be manufactured of plastic whereas plate 192 may be manufactured of metal, such that plate 192 may be secured to an interior surface of a convection microwave oven without melting or otherwise damaging plastic mounting bracket 12.

FIG. 15 is a perspective view of mixing device 190 of FIG. 14 showing mounting bracket 12 frictionally secured on mounting plate 192 by arms 194.

The illustrated example embodiments of FIGS. 1-15 are shown to illustrate the principles and concepts of the invention as set forth in the claims below, and a variety of modifications and variations may be employed in various implementations while still falling within the scope of the claims below.

I claim:

1. A microwave oven mixing device, comprising:
a mounting bracket structured for securement to an interior surface of a cooking compartment of a microwave oven;
a horizontal beam pivotally mounted to said mounting bracket and structured for pivotal movement on said mounting bracket during operation of said microwave oven; and
a mixing blade operatively connected to said horizontal beam and structured for placement within a food container during operation of said microwave oven.

2. A mixing device according to claim 1 further comprising a horizontal arm telescopingly mounted on said horizontal beam and structured for telescopic movement along said horizontal beam during operation of said microwave oven, wherein said mixing blade is operatively connected to said horizontal arm.

3. A mixing device according to claim 2 further comprising a vertical arm mounted on said horizontal arm, said mixing blade telescopingly mounted on said vertical arm.

4. A mixing device according to claim 3 wherein said mixing blade includes a ratchet device that provides indexed incremental telescopic movement of said blade on said vertical arm.

5. A mixing device according to claim 4 wherein said mixing blade includes a ratchet knob positioned upwardly from a food contacting portion of said mixing blade.

6. A mixing device according to claim 1 wherein said horizontal beam includes a pivot bar pivotally mounted to said mounting bracket and wherein said mounting bracket includes a recess which allows disengagement of said pivot bar from said mounting bracket when said horizontal beam is positioned in a predetermined pivotal orientation with respect to said mounting bracket.

7. A mixing device according to claim 6 wherein said predetermined pivotal orientation comprises the horizontal beam being pivoted ninety degrees from a position extending straight outwardly from the mounting bracket.

8. A mixing device according to claim 2 wherein said horizontal arm comprises a central region and an end region positioned opposite said central region from said mounting bracket, said mixing blade operatively connected to said end region, said end region structured for rotational movement with respect to said central region wherein rotational movement of said end region causes rotational movement of said mixing blade with respect to said mounting bracket.

9. A mixing device according to claim 8 wherein said horizontal arm comprises a locking mechanism which allows disengagement of said end region from said central region when said end region is positioned in a predetermined rotational orientation with respect to said central region.

10. A mixing device according to claim 9 wherein said predetermined rotational orientation comprises said end region being rotated ninety degrees from a position wherein said mixing blade extends straight downwardly from the horizontal arm.

11. A mixing device according to claim 9 wherein said locking mechanism comprises a projection positioned on an exterior surface of said central region and a guide wall positioned on an interior surface of said end region, said guide wall including an opening which allows movement of said projection therethrough when said end region is positioned in said predetermined rotational orientation.

12. A mixing device according to claim 1 wherein said mixing blade is removable from said horizontal beam, and wherein said blade is chosen from the group consisting of a pasta blade, a short blade, a whipping blade and a coffee cup blade.

13. A mixing device according to claim 1 further comprising double stick foam tape secured to said mounting bracket and adapted for mounting said mounting bracket to an interior surface of a cooking compartment of a microwave oven.

14. A microwave oven comprising:
an interior surface that defines a compartment for heating food therein;
a rotating platform positioned within said interior compartment and structured for receiving a food container thereon, said rotating platform rotating during operation of said microwave oven;
a mounting bracket secured to said interior surface;
a mixing arm pivotally mounted to said mounting bracket and structured for pivotal movement with respect to said mounting bracket during operation of said microwave oven; and
a mixing blade operatively connected to said mixing arm and structured for placement within a food container received on said rotating platform.

15. A microwave oven according to claim 14 wherein said mixing arm comprises a first section pivotally mounted to said mounting bracket and a second section telescopingly mounted on said first section and having said mixing blade secured thereto, wherein said second section is structured such that movement of a food container with said rotating platform during operation of said microwave oven causes telescoping movement of said second section with respect to said first section such that said mixing blade tracks movement of said food container during operation of said microwave oven.

16. A microwave oven according to claim 14 wherein said mixing blade is telescopingly and rotationally connected to said mixing arm.

17. A microwave oven according to claim 14 wherein said mixing arm defines a generally I-beam cross-sectional shape.

18. A method of mixing food during heating in a microwave oven, comprising the steps of:
placing a food container containing food therein on a rotating platform of a microwave oven;
pivoting a horizontal arm about a horizontal arm mounting bracket secured to an interior surface of said microwave oven such that said horizontal arm is positioned over said food container;
rotating a mixing blade about said horizontal arm into a downward position such that said mixing blade is received within said food container; and
operating said microwave oven such that said rotating platform rotates said food container and such that food contained within said food container is heated,
wherein rotation of said food container with said food contained therein applies a force to said mixing blade which causes pivotal movement of said horizontal arm about said horizontal arm mounting bracket such that said mixing blade tracks movement of said food container during operation of said microwave oven.

19. A method of mixing food according to claim 18 wherein said horizontal arm comprises a first section pivotally secured to said mounting bracket and a second section slidingly mounted on said first section, wherein said method further comprises sliding said second section on said first section of said horizontal arm such that said mixing blade is centered within said food container prior to operation of said microwave oven, and wherein rotation of said food container with said food contained therein applies a force to said mixing blade which causes sliding movement of said second section on said first section during operation of said microwave oven such that said mixing blade tracks movement of said food container during operation of said microwave oven.

20. A method of mixing food according to claim 18 further comprising, after heating of said food contained within said food container, rotating said mixing blade about said horizontal arm such that said mixing blade is removed from said food container, and thereafter removing said food container from said microwave oven, wherein said mixing blade is retained within said food container during heating by a ratchet device and wherein rotating said mixing blade to remove said blade from said food container is conducted without loosening a fastening device.

21. A mixing device according to claim 1 further comprising a suction cup secured to said mounting bracket and adapted for mounting said mounting bracket to an interior surface of a cooking compartment of a microwave oven.

22. A mixing device according to claim 1 further comprising a mounting plate secured to said mounting bracket and adapted for mounting said mounting bracket to an interior surface of a cooking compartment of a microwave oven.

23. A mixing device according to claim 3 wherein said mixing blade includes a temperature sensing device.

24. A mixing device according to claim 1 wherein said horizontal beam includes a pivot bar pivotally mounted to said mounting bracket and wherein said mounting bracket includes a pair of snap arms that releasably secure said pivot bar therein.

25. A mixing device according to claim 2 wherein said horizontal beam includes a projection and said horizontal arm includes a mating recess and wherein said depression of said projection removes said projection from said mating recess and facilitates disconnection of said horizontal arm from said horizontal beam.
